(19) United States
(12) Patent Application Publication
(10) Pub. No.: US 2021/0372498 A1
(43) Pub. Date: Dec. 2, 2021

(54) Two-Dimensional Folded Beam-Based Passive Energy Absorber

(71) Applicant: Massachusetts Institute of Technology, Cambridge, MA (US)

(72) Inventor: Maor Farid, Brighton, MA (US)

(21) Appl. No.: 16/942,124

(22) Filed: Jul. 29, 2020

Related U.S. Application Data
(60) Provisional application No. 63/030,755, filed on May 27, 2020.

(51) Int. Cl. F16F 7/116; F16F 7/108; B33Y 50/02; B33Y 80/00; B33Y 10/00

(52) U.S. Cl. CPC F16F 7/116; F16F 7/108; B33Y 50/02; F16F 2224/02; B33Y 10/00; F16F 2224/0208; B33Y 80/00

(57) ABSTRACT

A two-dimensional passive energy absorber device has an integral body with a first face and a second face separated by an edge height H. The body includes a platform, a rigid frame surrounding the platform, and a plurality of symmetrical flexible folded beams. The platform and the frame have the same profile shape is arranged to concentrically align, and each of the symmetrical folded beams connects between a frame edge and a platform edge that is not parallel to the frame edge.

### CROSS-REFERENCE TO RELATED APPLICATIONS

This application claims the benefit of U.S. Provisional Patent Application Ser. No. 63/030,755, filed May 27, 2020, entitled “Two-Dimensional Passive Energy Absorber, and Two-Dimensional Motion Sensor,” which is incorporated by reference herein in its entirety.

### FIELD OF THE INVENTION

The present inventions relate to energy transfer devices, and in particular to a two-dimensional passive energy absorber.

### BACKGROUND OF THE INVENTION

When two- or three-dimensional flexible elements are subjected to external force in a given direction, they may deflect to a diverse direction due to coupling between those directions. This motion might be undesired in various mechanical applications, such as Micro and Nano Electromechanical (MEMS, NEMS) devices, micro sensors and actuators, passive energy absorbers devices (PEAs) in various scales and sizes, etc. This issue is usually solved by applying a more sophisticated mechanical design. As a result, the complexity of the system increases, which may result in undesired nonlinearities. Thus, complex nonlinear phenomena may occur, such as bi-stability and buckling phenomena for external static forces and nonlinear dynamical regimes for time dependent external disturbances, or even chaotic behaviors under specific circumstances.

PEAs are devices that absorb undesired kinetic energy from a system of interest (main system (MS)). The PEA serves as a small attachment to the MS. When the MS is exposed to external disturbances, energy flows from the environment to the MS, causing the PEA to absorb the energy from the MS and convert the energy to heat via damping. The linear PEA is referred to as tuned mass damper (TMD). Most TMD designs are only effective in a single direction (one dimension). Therefore, there is a need in the industry to address one or more of the abovementioned applications.

### SUMMARY OF THE INVENTION

Embodiments of the present invention provide a two-dimensional passive energy absorber. Briefly described, the present invention is directed to a two-dimensional passive energy absorber device having an integral body with a first face and a second face separated by an edge height H. The body includes a platform, a rigid frame surrounding the platform, and a plurality of symmetrical flexible folded beams. The platform and the frame have the same profile shape is arranged to concentrically align, and each of the symmetrical folded beams connects between a frame edge and a platform edge that is not parallel to the frame edge. The symmetricity of the device prevents coupling between the directions of motion, and by that lead to a simple and tractable dynamics of the oscillating platform.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the inventions, and are incorporated in and constitute a part of this specification. The drawings illustrate embodiments of the inventions and, together with the description, serve to explain the principals of the inventions. Both inventions have similar mechanical design, which is described in the figures attached.

FIG. 1 is a schematic diagram of a first embodiment of a two-dimensional passive energy absorber from an isometric view.

FIG. 2 is a schematic diagram of the first embodiment of FIG. 1 from top view.

FIG. 3 is a schematic diagram of the first embodiment of FIG. 2 showing a detail of a beam.

FIG. 4 is a schematic diagram of the first embodiment of FIG. 2 showing displacement of the platform under a normal force applied on the right face of the frame.

FIG. 5 is a schematic diagram showing a detail of the first embodiment of a two-dimensional passive energy absorber of FIG. 1 with four interface holes.

FIG. 6A is a schematic diagram of a 1D Tuned Mass Damper (1D-TMD).

FIG. 6B is a schematic diagram of a system incorporating the first embodiment of FIG. 2.

FIG. 7 is a schematic diagram of a second embodiment of a one-dimensional square platform supported by one-dimensional folded beam-based linear springs from a top view.

### DETAILED DESCRIPTION

The following definitions are useful for interpreting terms applied to features of the embodiments disclosed herein, and are meant only to define elements within the disclosure.

As used within this disclosure, an “integrally formed” object indicates the object is formed of a single, contiguous piece of material, rather than being composed of separately formed components that are subsequently joined together.

Reference will now be made in detail to embodiments of the present invention, examples of which are illustrated in the accompanying drawings. Wherever possible, the same reference numbers are used in the drawings and the description to refer to the same or like parts.

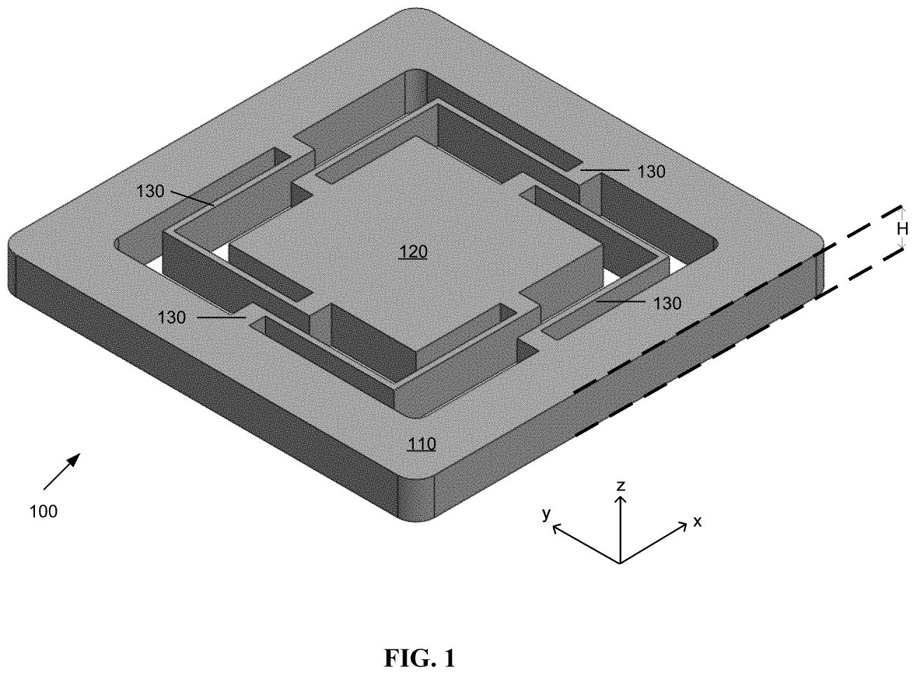

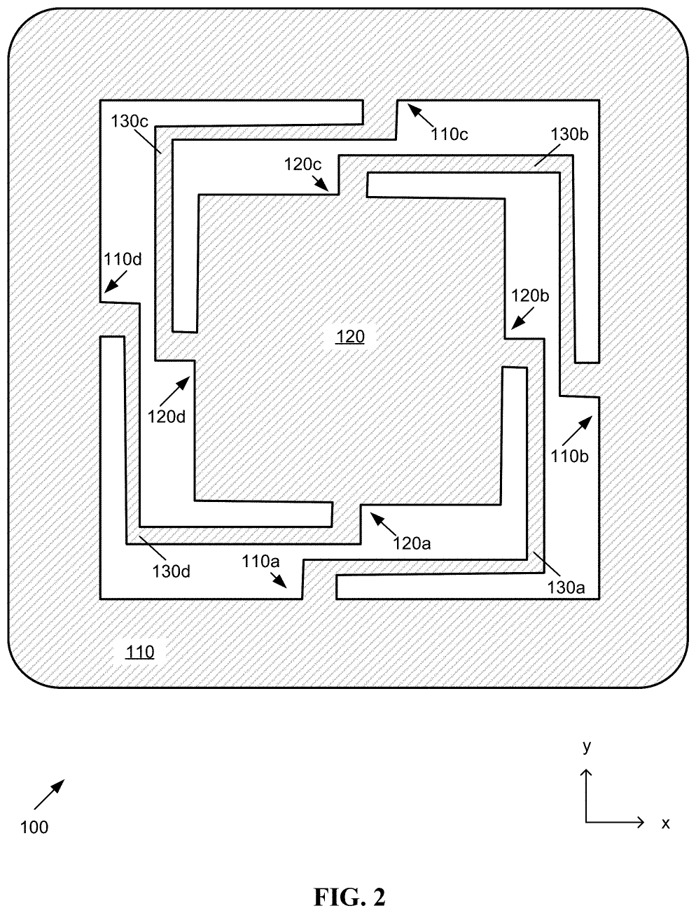

The embodiments described herein overcome the multi-directional coupling in a two-dimensional passive energy absorber (2D-PEA) 100 shown by FIG. 1 by using a mechanical design with high order of symmetry in the x-y plane. Under a first embodiment a 2D-PEA device 100 has four springs implemented identical folded linear beams 130a-d (FIG. 2), which make the system linear by definition, while preventing the existence of unwanted geometric nonlinearities. Dynamical features (i.e. natural frequencies) of this design can be easily calculated and tuned by varying the length of the folded-beams according to Eq. 1 that associates the material and geometrical properties of two clamped cantilever beams 130 and their natural frequencies:

$$ω \approx 2 \cdot 1.8 \; 7 {5}^{2} \sqrt{\frac{EI}{ρ {L}^{4}}} \qquad ( Eq . 1 )$$

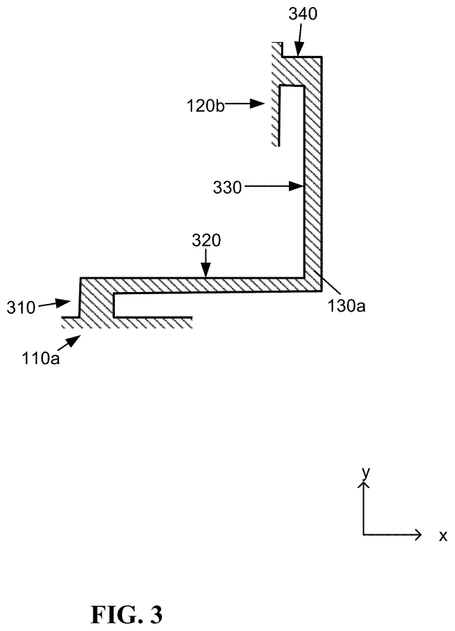

Here, the factor of 2 indicates that two of the four springs (beams 130) are active simultaneously, i.e. connected in parallel to each other, while the other two springs are negligible. Parameters E, I, p and L are Young modulus, the moment of inertia of the beam cross-section, the material density, and length of the beam portion 320,330 (FIG. 3) respectively, where the length is measured in just the portion of the beam 320, 330 orthogonal to the corresponding applied force. For example, if the force is received along the x-axis, the length L is the length of the beam in the y-axis. The natural frequencies can be also measured or verified by experiment or computational simulation (finite element for example). The moment of inertia for a beam portion 320, 330 with a rectangular cross section is given by:

$$I = \frac{h {w}^{3}}{12} \qquad ( Eq . 2 )$$

where w is the width (the size in the bending (x-y) direction) and h is the height (in the z direction) of the rectangular cross section.

As described below, embodiments of the 2D-PEA 100 can absorb energy in two direction, while not leading to an energy leakage to the third dimension. Forcing the motion of the system to two dimensions is achieved by appropriate selection of the cross-sections of the beams. Here, bending of the beams 130 towards the z-axis is prevented, and hence energy leakage to the third dimension (z-axis) is also prevented. The design of the embodiments reduces complexity and costs in various manufacturing methods. For example, the embodiments facilitate production of a 2D-PEA by 3D printing (“additive manufacturing”). Additionally, the embodiments may be manufactured as a single piece of material. Exemplary materials for the 2D-PEA include, but are not limited to plastics such as ABS, ABSi, ABS-ESDI, and metals such as Aluminum: AlSiMg, Steel: Stainless Steel 17-4, and Stainless Steel 316L, among others. Manufacturing the 2D-PEA from a single material provides high reliability and low undesired wearing, fraction, and stress concentration using various 3D printing processes, for example but not limited to Selective Laser Sintering (SLS) for plastic printing and Direct Metal Laser Sintering (DMLS) for metal printing. As a result, the device has a high quality-factor, making it a natural choice for MEMS devices, micro clocks, oscillators, and other high-performance and sensitive systems.

FIGS. 1 and 2 shown the first exemplary embodiment 2D-PEA 100 has a two-dimensional folded beam-based linear spring that includes a frame 110 surrounding a platform 120. Under the first embodiment 2D-PEA 100, the frame 110 and the platform 120 are substantially square in profile, having an edge height H. The frame 110 is attached to the platform 120 by a plurality of folded beams 130a-d. Under the first embodiment, the frame 110, the platform 120, and the plurality of folded beams 130a-d are integrally formed of a single material.

Each beam 130a-d connects from an interior frame surface 110a-d to an exterior platform surface 120a-d. However, rather than each beam 130a connecting from an interior frame surface 110a-d to an adjacent parallel exterior platform surface 120a-d, each beam 130a-d connects from an interior frame surface 110a-d to an orthogonally oriented exterior platform surface 120a-d. For example, a first beam 130a connects from a horizontal center portion of the frame 110 at an exterior platform surface 120a to the center of a vertical exterior platform surface 120b.

FIG. 3 is a detail of a first beam 130a. A first portion 310 of the beam 130a extends orthogonally (along the y axis) from the center of the interior frame surface 110a. A second portion 320 of the beam 130a branches at a right angle from the first portion 310 to extend parallel to the of interior frame surface 110a. A third portion 330 of the beam 130a branches at a right angle from the second portion 320 to extend parallel to the platform exterior portion 120b. A fourth portion 340 of the beam 130a branches at a right angle from the third portion 330 to attach to a center portion of the platform exterior portion 120b. Each of the second beam 130b, the third beam 130c, and the fourth beam 130d have similar portions that connect to successive respective sides of the frame 110 and platform 120.

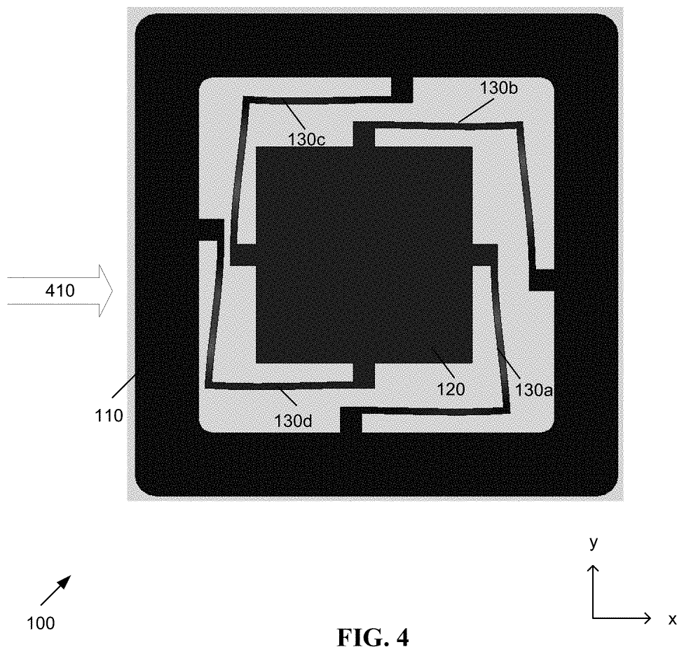

In general, the beams 130a-d are substantially thicker in the z direction (along edge height H) than they are wide in the x-y plane, allowing the beams 130a-d to flex in the x-y plane, while not diverting transpositional energy in the z direction. For example, as shown by FIG. 4, when translational energy 410 parallel to the x-axis is applied to the frame 110 at the indicated position, the beams 130a-d flex as shown in the x-y plane, causing a translation of the platform 120 to move along the x-axis toward to a portion of the frame 110 receiving the applied translational energy 410, which performs oscillations around its equilibrium (undisturbed) position. While FIG. 4 shows the motion in one dimension (along the x-axis), a force applied to the frame 110 in the x-y plane that is not parallel to the x-axis or the y-axis will cause the beams 130a-d to flex such that the platform 120 translates in the x-y plane proportionally according to the x-component and the y-component respectively of the applied force 410. The 2D-PEA device 150 may be attached to the MS, for example, by gluing the frame 110 to the MS, or by screwing the frame to the MS using the interface holes 111.

While the first embodiment is implemented with a square frame and a square platform for clarity, alternative embodiments may have different shaped elements, for example, but not limited to a circular frame and/or platform. Preferably, the platform and the frame have a common profile shape in the x-y plane, and the profile shape is symmetrical. As shown in FIG. 1, the thickness of the beams 130 in the z-axis is larger than the thickness with respect to other directions in order to prevent undesired oscillations in the z-direction, i.e. energy leakage.

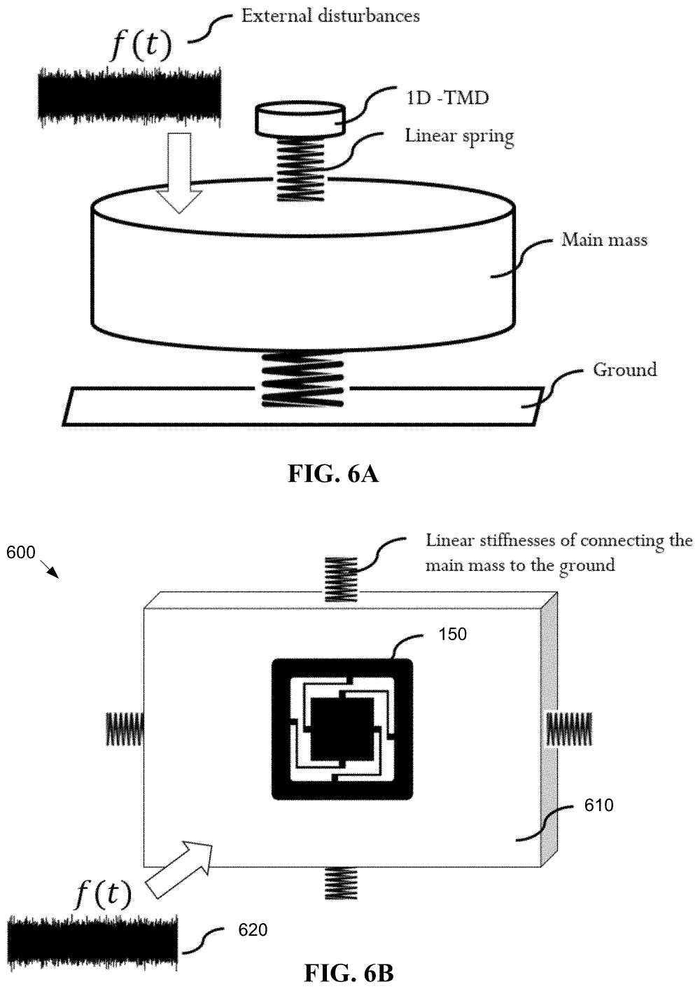

The first embodiment of a two-dimensional (2D) passive energy absorber device 150, is shown in the context of a system in FIG. 6B. For example, as shown by FIG. 6B, the 2D-PEA device 150 may incorporated into (for example, attached to) a main system 610 to absorb 2D motion of the main system 610. The 2D-PEA device 150 responds to motion in two directions (x-axis and y-axis) simultaneously without coupling between the x-axis and y-axis and without giving rise to complex nonlinear dynamical phenomenon. The 2D-PEA device 150 can be used for any system which exhibits multidimensional motion, such as automotive, airplane, mechanical systems. For the 2D-PEA device 150, the multi-directional coupling is overcome by using a mechanical design described above regarding the first embodiment. Moreover, the simple design of the 2D-PEA device 150 enables low-cost manufacturing. An integrated single-piece design leads to small damping and high-quality factor i.e. high-responsiveness, of the 2D-PEA 150.

The 2D-PEA 150 absorbs energy from the main system 610. When the main system 610 is exposed to external forces 520, the main system 610 is accelerated in the direction of the applied forces. The platform 110 of the 2D-PEA 150 moves in concert with the main system 610. Influenced by the motion of the main system 610, the moving platform 120 of the 2D-PEA 150 responds to the motion by oscillating. Vibration mitigation of the MS 610 is achieved when the oscillating motion of the 2D-PEA 150 is converted to heat.

When the main system (MS) 610 is exposed to bi-directional/planar external disturbances 620, The MS 610 may undesirably oscillate in both directions. Energy flows from the MS 610 to the 2D-PEA 150 via the dynamical mechanism of resonance. The 2D-PEA 150 converts the energy to heat via damping. Here, the structural damping provided by the 2D-PEA 150 is the source of damping, however additional damping mechanisms may also be used in concert, for example, a dashpot or piston, among others.

FIG. 6A is a diagram illustrating a scheme modeling a second embodiment (described below): a one-dimensional tuned mass damper (1D-TMD), while FIG. 6B shows the first embodiment two-dimensional tuned mass damper (2D-PEA) 150. The dimensions of the 2D-PEA are defined according to the system of interest, and chosen in order to satisfy non-dimensional relations with respect to it, for example mass-ratio. For example, the desired absorption abilities may be obtained for mass ratio of 10% 2D-PEA 150 with respect to the overall mass of the system of interest 610. The geometric dimensions of the energy absorption device 150 are driven by its desired mass, which is a property of high importance in terms of energy absorption performances. The 2D-PEA 150 device may be made by any material which is durable under the characteristic vibration, for example but not limited to stainless steel, among other possible materials. Tuning of the mass ration of the platform 120 may be made, for example by changing the geometric dimensions of the 2d-PEA 150, or by material reduction of the moving platform by milling, among others.

For purpose of illustration only, for a 100 kg system of interests made of stainless steel, a non-limiting exemplary 2D-PEA 150 may be approximately may have a platform with a side length of 400 mm, a thickness of 80 mm, a beam length of 318 mm, and an internal length of the frame of 667 mm. The operation of the 2D-PEA 150 as described above assumes the 2D-PEA 150 is operating below a threshold amplitude, where the threshold amplitude indicates a level of force/vibration that results in impacts between the oscillating beams 130 and the frame 110 of the 2D-PEA 150. The threshold force amplitude may be determined by experiment.

The energy absorption performance of the 2D-PEA 150 is governed by the following three unidimensional parameters: the ratio between the natural frequencies of the moving platform 120 (denoted by m) and the sum masses of the frame 110 and the MS 610 (denoted by M), denote by ε, and the damping coefficient of the 2D-PEA 150 denoted by δ, given by the following expression:

$$ϵ = \frac{m}{M} , δ = \frac{c}{2 m ω} \qquad ( Eqs . 3 , 4 )$$

where m and M are the masses of the 2D-PEA 150 and the main system 610, respectively, and parameters c and ω are the dimensional damping coefficient of the 2D-PEA 150 and natural frequency of the MS 610.

While as depicted herein the shape of the 2D-PEA 150 (FIG. 6B) is square, in alternative embodiments the 2D-PEA 150 (FIG. 6B) may have other shapes. The actual size of the 2D-PEA 150 (FIG. 6B) may be chosen freely in order to meet the desired sensing or vibration mitigation performances, respectively.

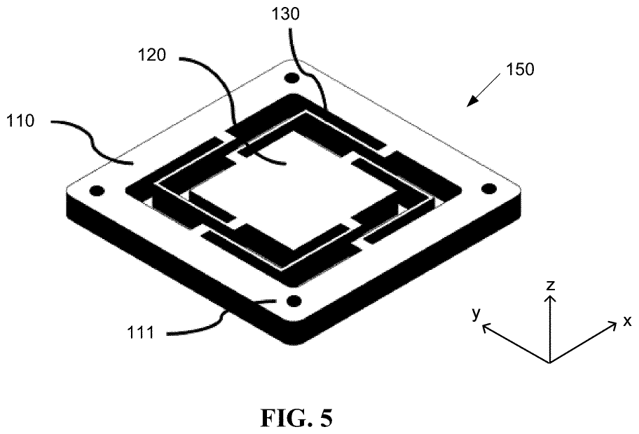

The interface holes 111 shown in FIG. 5 may be used to attach the 2D-PEA to the system of interest. The attachment can be done also by adhesion applied between the face of the frame 110 and the system. When attaching the 2D-PEA 150 to the MS 610, surfaces the platform 120 and beams 130 adjacent to the system 610 are preferably not in direct contact with the system 610, allowing the platform 120 and beams 130 to oscillate freely. For example, spacers (not shown) may be used in conjunction with fasteners inserted through the interface holes into the system 610 such that energy is transferred from the system 610 to the frame 110.

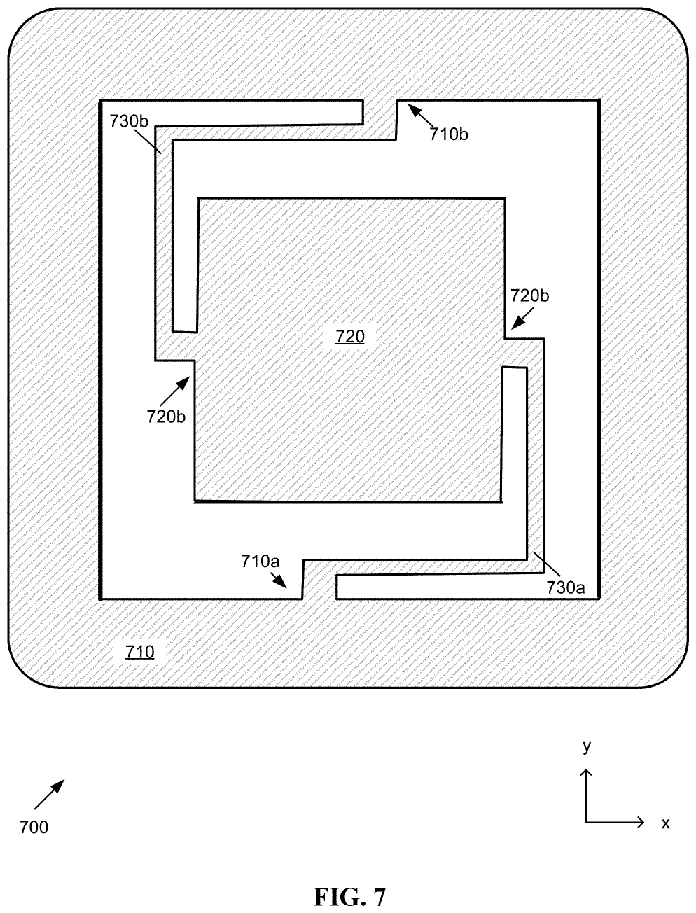

Under a second exemplary embodiment, shown in FIG. 7, the invention may be implemented as a one-dimensional passive energy absorber 1D-PEA design 700 having a frame 710, a platform 720, and two folded beams 730a and 730b. The 1D-PEA under the second embodiment may be implemented according to the descriptions above regarding the second embodiment, for example, having similar materials and relative dimensions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A two-dimensional passive energy absorber (2D-PEA) device comprising:
an integral body formed of a first material comprising a first face and a second face parallel to the first face separated by an edge height H, further comprising:
a platform having a symmetrical profile shape;
a rigid frame surrounding the platform comprising an interior edge of the symmetrical profile shape and exterior edge of the symmetrical profile shape; and
a plurality of at least four symmetrical folded beams, each beam comprising:
a frame connecting portion;
a platform connecting portion;
a first flexible portion comprising a first end connected to the frame connecting portion and a second end; and
a second flexible portion comprising a first end connected to the platform connecting portion and the second end connecting to the first flexible portion second end;
wherein the platform profile shape is arranged to align with the frame profile shape, and each of the symmetrical folded beams connects between a frame edge and a platform edge that is not parallel to the frame edge.

2. The device of claim 1, wherein the plurality symmetrical folded beams comprises at least four folded beams.

3. The device of claim 1, wherein the first flexible portion and the second flexible portion each have a width W smaller than the height H and a length L longer than the width W and the height H.

4. The device of claim 2, wherein a first pair of the plurality of symmetrical folded beams are oriented to facilitate oscillation of the platform in a first direction, a second pair of the plurality of symmetrical folded beams are oriented to facilitate oscillation of the platform in a second direction, and the first direction and the second direction are in a plane parallel to the first face and the second face.

5. The device of claim 4, wherein the first direction is orthogonal to the second direction.

6. The device of claim 1 wherein:
the profile shape is a square comprising four face edges;
the plurality of symmetrical folded beams consists of four folded beams; and
the frame connecting portion of each beam connects to a frame edge perpendicular to a platform edge connecting to the platform connecting portion.

7. The device of claim 1, configured to attach to a main system in an orientation to absorb energy of motion of the main system in two directions in a plane parallel to the first face and the second face.

8. The device of claim 7, further comprising a plurality of interface holes in the rigid frame between the first face and the second face configured to receive a fastener therethrough, wherein the fastener is configured to attach the device to the main system.

9. The device of claim 1, wherein the first material comprises one of the group consisting of plastic, aluminum, and steel.

10. A passive energy absorber device comprising:
an integral body formed of a first material comprising a first face and a second face parallel to the first face separated by a height H, further comprising:
a platform having a symmetrical profile shape;
a rigid frame surrounding the platform comprising an interior edge of the symmetrical profile shape and exterior edge of the symmetrical profile shape; and
a first and second symmetrical folded beam, each beam having a frame connecting portion, a platform connecting portion, a first flexible portion comprising a first end connected to the frame connecting portion and a second end, and a second flexible portion comprising a first end connected to the platform connecting portion and the second end connecting to the first flexible portion second end at a right angle;
wherein the platform profile shape is a square arranged to be aligned with the frame profile shape, the first flexible portion and the second flexible portion each have a width W smaller than the height H and a length L longer than the width W and the height H, and the frame connecting portion of each beam connects to a frame edge perpendicular to a platform edge connecting to the platform connecting portion.

11. A computer-readable medium comprising non-transitory instructions for execution by an additive manufacturing device to produce a two-dimensional passive energy absorber device comprising:
an integral body comprising a first face and a second face parallel to the first face separated by an edge height H, further comprising:
a platform having a symmetrical profile shape;
a rigid frame surrounding the platform comprising an interior edge of the symmetrical profile shape and exterior edge of the symmetrical profile shape; and
a plurality of at least four symmetrical folded beams, each beam comprising a frame connecting portion, a platform connecting portion, a first flexible portion comprising a first end connected to the frame connecting portion and a second end, and a second flexible portion comprising a first end connected to the platform connecting portion and the second end connecting to the first flexible portion second end;
wherein the platform profile shape is arranged to be aligned with the frame profile shape, a first pair of the plurality of symmetrical folded beams are oriented to facilitate oscillation of the platform in a first direction, a second pair of the plurality of symmetrical folded beams are oriented to facilitate oscillation of the platform in a second direction, and the first direction and the second direction are in a plane parallel to the first face and the second face.

12. The computer-readable medium of claim 11, wherein the first direction is orthogonal to the second direction.

13. The computer-readable medium of claim 11, wherein the two-dimensional passive energy absorber device is formed of a single material.

14. The computer-readable medium of claim 12, wherein the single material comprises one of the group consisting of plastic, aluminum, and steel.
